(19) United States
(12) Patent Application Publication
(10) Pub. No.: US 2013/0317904 A1
(43) Pub. Date: Nov. 28, 2013

(54) SYSTEMS AND METHODS FOR DETERMINING ADVERTISING COMPLIANCE

(71) Applicant: Brand Enforcement Services Limited, Hong Kong (CN)

(72) Inventor: Edwin Tan, Beaverton, OR (US)

(21) Appl. No.: 13/831,576

(22) Filed: Mar. 14, 2013

Related U.S. Application Data
(60) Provisional application No. 61/652,081, filed on May 25, 2012.

(51) Int. Cl. G06Q 30/02

(52) U.S. Cl. CPC G06Q 30/0248
USPC 705/14.47

(57) ABSTRACT

Systems and methods for determining advertising compliance are provided. More specifically, various embodiments of the present invention relate to systems and methods for tracking, ranking, and enforcing the placement of advertisements in websites in accordance with one or more advertising policies. Some embodiments provide for a system where a user can enter text advertising campaigns for evaluation. The results can be ranked and the user can determine if any disputes need to be submitted for the violation of advertising policies.

### CROSS-REFERENCE TO RELATED APPLICATIONS

This application claims priority to U.S. Provisional Application Ser. No. 61/652,081 filed May 25, 2012, which is incorporated herein by reference for all purposes.

### TECHNICAL FIELD

Various embodiments of the present invention generally relate to systems and methods for determining advertising compliance and for determining the relevance of the advertisement placement. More specifically, various embodiments of the present invention relate to systems and methods for tracking and enforcing the placement of online advertisements on various websites.

### BACKGROUND

Placement of online advertisements throughout the Internet within e-mail messages and on web pages such as search engine results pages, social network web pages, and others has become a multi-billion dollar business. Online advertising allows for marketing messages or ads to be placed using email and the World Wide Web. One of the reasons for the success of online advertising is that online advertising removes the geographic or temporal restraints found in many other forms of advertising. In addition, online advertising allows for the customization of ad placement based on observations of the user.

Users have many choices of the types of advertisements which could be most beneficial for their target audience. Examples of the different types of online advertising include, but are not limited to, streaming video advertisements, e-mail advertising, floating advertisements, expanding advertisements, pop-up and pop-under advertisements, along with many others. In addition to the many different types of advertisements, there are many different pricing models. Common examples include cost per thousand impressions (CPT), cost per view (CPV), pay per click (PPC), and others. A CPT pricing model allows advertisers to pay per thousand loads of an advertisement. A CPV pricing model results in payment for each individual view of an advertisement. A PPC pricing model results in payment from the advertisers each time a viewer clicks on the advertisement.

Companies and individuals paying for the placement of these advertisements have a strong interest in ensuring that their marketing dollars are being effectively spent and are complying with any restrictions or requirements set forth in the advertising contracts. Historically, there has been no effective way to independently ensure compliance with these requirements. As such, the companies and individuals have had to rely upon the vendor for assurances that the requirements and policies set forth by the contracts are being followed. Consequently, improved techniques are needed for effectively determining compliance with various advertising policies.

### SUMMARY

Various embodiments of the present invention generally relate systems and methods for determining advertising compliance with various policies associated with particular advertisements and/or companies placing the ads. More specifically, various embodiments of the present invention relate to systems and methods for tracking and enforcing the placement of advertisements on various websites.

Some embodiments include receiving a set of advertisements (e.g., text advertisements or image advertisements) to be monitored. Each advertisement identified in the set of advertisements may be associated with an advertisement policy that specifies restrictions or preferences (e.g., timing, website content restrictions, website exclusion lists, website inclusion lists, etc.) regarding the placement of the advertisements. The set of advertisements may be submitted to a compliance engine to determine compliance with the advertisement policy associated with each advertisement. Upon completion, the compliance engine may return a compliance status for the set of advertisements.

Embodiments of the present invention also include computer-readable storage media containing sets of instructions to cause one or more processors to perform the methods, variations of the methods, and other operations described herein.

An advertisement compliance system, in accordance with some embodiments, may include a database, a monitoring module, a compliance engine, a report module, an aggregator, and/or a spam module. The database may be used to store snapshots of an indexed set of websites over various time periods. The monitoring module may be configured to crawl the Internet and create entries within the database. The compliance engine can receive an advertisement and search the indexed set of websites within the database for the advertisement. In some embodiments, the compliance engine may use a comparator to compare the advertisement to portions of the indexed set of websites and generate a similarity score. Then, the report module can receive search results from the compliance engine and generate a compliance report based on the various advertising policies. The results can be presented in a report (e.g., on a dashboard).

In some cases, the database includes a collection of e-mails messages. The e-mail messages can be aggregated identified spam messages from multiple sources. The spam module can receive the messages from the aggregator. Then, the spam module can index content from messages identified by visiting each link within the messages and storing a snapshot within the database.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF DRAWINGS

Embodiments of the present invention will be described and explained through the use of the accompanying drawings in which:

FIG. 1 illustrates an example of an Internet-based advertising environment in which some embodiments of the present invention may be utilized;

FIG. 2 shows a block diagram with exemplary components of an advertising compliance system in accordance with one or more embodiments of the present invention;

FIG. 3 is a flowchart illustrating exemplary operations for determining an advertising compliance level in accordance with various embodiments of the present invention;

FIG. 4 is a flowchart illustrating exemplary operations for setting advertising policies in accordance with some embodiments of the present invention;

FIG. 5 is a flowchart illustrating exemplary operations for monitoring and notification of advertising compliance in accordance with various embodiments of the present invention;

FIG. 6 is a flowchart illustrating exemplary operations for ranking advertising vendors in accordance with various embodiments of the present invention; and

FIG. 7 illustrates an example of a computer system with which one or more embodiments of the present invention may be utilized.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION OF THE INVENTION

Various embodiments of the present invention generally relate to systems and methods for determining advertising compliance and for determining the relevance of the advertisement to the website and website's audience. More specifically, various embodiments of the present invention relate to systems and methods for tracking, ranking, and enforcing the placement of advertisements on various websites and other distribution channels such as e-mail. For example, various embodiments provide for a system where a user can enter text advertising campaigns for evaluation.

The system can search a database of indexed entries (e.g., webpages, e-mails, etc.) to determine if associated advertisements appear (e.g., on a snapshot of a web page). Each entry can be associated with one or more content categories. Examples include media piracy, conflict and crime, gambling, drugs and alcohol, tragedy and emergency, profanity, hate speech, sexually suggestive, error pages, and others. These content categories can be used to determine if advertisements are being placed appropriately. In some cases, the content categories can be used to create a blacklist of URLs and domain names indicating places advertisers do not want to advertise. The system can aggressively scan the content of these websites to ensure the advertisements are not placed on them.

In some embodiments, the advertising compliance system can be used by advertisers to determine if their advertisements are actually appearing along with the rate/incidence. A report can be provided to the advertising companies/intermediaries on a regular basis. In addition, the historical capture available in many embodiments allows the user to review and evaluate the advertisement placement manually or automatically.

Spam and phishing can also be monitored by various embodiments of the present invention. In some embodiments, copies of spam messages, possibly aggregated from multiple sources, may be collected. The content of the spam messages that mention brand can be indexed and all links from spam may be visited and indexed by various embodiments. In some cases, screenshots can be collected, domain names of spam sites can be analyzed for brand enforcement and the results scored or ranked.

In accordance with one or more embodiments of the present invention, two result types/lists may be created. A list of all messages may be created and a list of all web pages linked to from spam can be reported to the user. The web pages may be grouped by domain names, identified content, content category, and/or other features. An image-to-image comparison of possible phishing sites can be performed to determine the similarity with the client's own domain names. In some cases, screenshots of the client's own domain names, multiple levels deep may be collected and compared with the phishing websites. A similarity score can be computed based on the percentage of similarity between the client's websites and the phishing website. The phishing websites can be ranked accordingly along with other considerations (e.g., if WHOIS identifies a known spammer, etc.).

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

While, for convenience, embodiments of the present invention are described with reference to advertising compliance and relevance, embodiments of the present invention are equally applicable to various other brand related elements such as, but not limited to, slogans, products, and others. In addition, various embodiments of the present invention are also applicable to processing various reporting and monitoring services, pricing structures (e.g., allowing access to different features and/or tiers of service), distribution and delivery models (e.g., distributed computing or standalone applications), and/or interfaces.

The techniques introduced here can be embodied as special-purpose hardware (e.g., circuitry), or as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

### Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to various embodiments,” “in the embodiments shown,” “in one embodiment,” “in other embodiments,” and the like generally mean the particular feature, structure, or characteristic following the phrase is included in at least one embodiment of the present invention, and may be included in more than one embodiment of the present invention. In addition, such phrases do not necessarily refer to the same embodiments or different embodiments.

If the specification states a component or feature “may”, “can”, “could”, or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein “network” is intended to encompass any network capable of transmitting information from one entity to another. In some cases, a network may be comprised of multiple networks, even multiple heterogeneous networks, such as one or more border networks, voice networks, broadband networks, service provider networks, Internet Service Provider (ISP) networks, and/or Public Switched Telephone Networks (PSTNs), interconnected via gateways operable to facilitate communications between and among the various networks.

### General Description

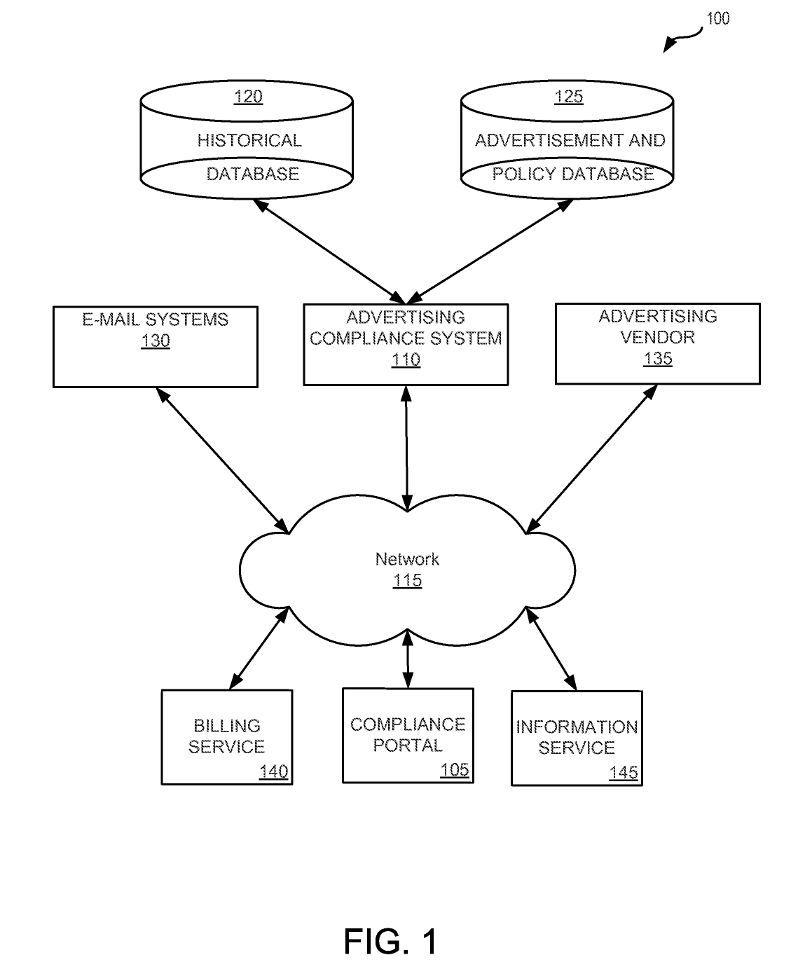

FIG. 1 illustrates an example of an Internet-based advertising monitoring and compliance environment 100 in which some embodiments of the present invention may be utilized. The environment illustrated in FIG. 1 includes a compliance portal 105, advertising compliance system 110, network 115, historical database 120, advertisement and policy database 125, e-mail systems 130, advertising vendors 135, billing service 140, and information service 145. A user can access advertising compliance system 110 through compliance portal 105.

Advertising compliance system 110 can be used for determining (e.g., in real-time, near-real time, at certain intervals, upon request, upon event detection, or a posteriori) advertising compliance with various policies associated with particular advertisements, advertising campaigns, and/or companies placing the ads. When a company would like to generate online marketing campaigns (sometimes referred to as Internet advertising, online advertising, or e-marketing) with one or more advertisements using the World Wide Web, the company contacts a middleman, intermediary, or advertising vendor 135. Advertising vendor 135 could be a search engine, a website owner, a blog owner, or other channel for directly or indirectly placing advertisements. In other cases, advertising vendor 135 could be a third-party for signing up and managing the placement of advertisements across one or more channels. For example, the vendor can be capable of ensuring the one or more advertisements are presented to a target audience using search engine results pages, banner advertisements, social network advertising, hyperstitial advertisements, interstitial advertisements, online classified advertising, dynamic banner advertisements, cross-platform advertisements, and e-mail marketing (including e-mail spam).

Advertising vendor 135 agrees to place or ensure placement of the advertisements in accordance with one or more policies. The policies, for example, can identify specific websites or types of websites where the advertisements must be presented or where the advertisements can never be presented. For example, the policy could specify an advertisement for a family vacation package should not be presented on adult rated websites. The policies can impose or identify other requirements, such as, but not limited to, target audience, number of views per day, number of views within a specified time period, number of total views for the life of the advertisements, distribution across marketing types (e.g., e-mail marketing, interstitial advertisements, etc.), distribution of placement, etc.

Compliance portal 105 can be used by the user for submission of a set of advertisements and associated policies that may be stored on advertisement and policy database 125. The advertisement policies may specify restrictions, requirements, or preferences (e.g., timing, website content restrictions, website exclusion lists, website inclusion lists, etc.) regarding the placement of the advertisements. The historical database 120 may be used to store snapshots and other information (e.g., collected from information services 145 or from advertising vendors) of an indexed set of websites over various time periods. In some cases, historical database 120 can include a collection of e-mails messages for evaluation. The e-mail messages can be aggregated from email systems 130. The advertising compliance engine can monitor how the e-mails and websites mentioned within the e-mails change over time.

The advertising compliance system 110 may crawl the Internet and create entries within the historical database 120. The entries can include a variety of information such as snapshots of the websites or e-mails with the advertisements, information regarding allocation or distribution across multiple advertising channels, geographical distributions, cost structures, and the like. Then, once enough information has been collected, a compliance report based on the various advertising policies may be generated. The results can be presented in a report (e.g., on a dashboard through compliance portal 105). Some results may be presented as alerts in order to quickly notify a user of violations of the advertising policy.

In addition, advertising vendors 135 may supply information to advertising compliance system 110. The information can include placement date and time, location, website statistical information, and other types of information that may be useful for determining advertising compliance and/or relevance. In some embodiments, any deviation from the policies can be used in correcting (possibly automatically) any billings through billing service 140 or for more closely monitoring future service. In addition, advertising compliance system 110 can be used to monitor phishing websites.

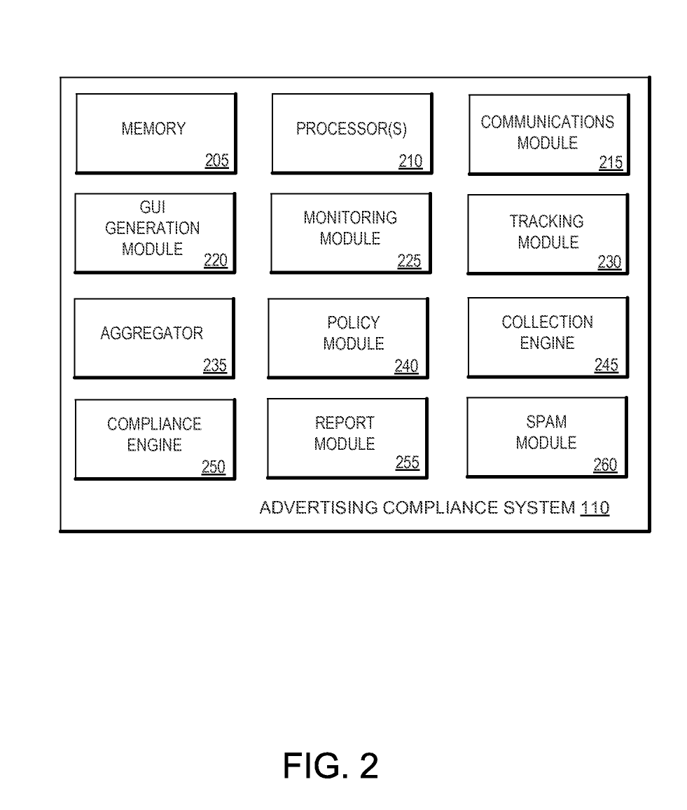

FIG. 2 shows a block diagram 200 with exemplary components of an advertising compliance system 110 in accordance with one or more embodiments of the present invention. According to the embodiments shown in FIG. 2, the advertising compliance system can include memory 205, one or more processors 210, communications module 215, graphical user interface (GUI) generation module 220, monitoring module 225, tracking module 230, aggregator 235, policy module 240, collection engine 245, compliance engine 250, report module 255, and spam module 260. Other embodiments of the present invention may include some, all, or none of these modules and components along with other modules, applications, and/or components. Still yet, some embodiments may incorporate two or more of these modules into a single module and/or associate a portion of the functionality of one or more of these modules with a different module. For example, in one embodiment, aggregator 235 and spam module 260 may be combined into a single module for monitoring advertisements in e-mails identified as spam.

Memory 205 can be any device, mechanism, or populated data structure used for storing information. In accordance with some embodiments of the present invention, memory 205 can encompass any type of, but is not limited to, volatile memory, nonvolatile memory and dynamic memory. For example, memory 205 can be random access memory, memory storage devices, optical memory devices, media magnetic media, floppy disks, magnetic tapes, hard drives, SIMMs, SDRAM, DIMMs, RDRAM, DDR RAM, SODIMMS, erasable programmable read-only memories (EPROMs), electrically erasable programmable read-only memories (EEPROMs), compact disks, DVDs, and/or the like. In accordance with some embodiments, memory 205 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 205.

Memory 205 may be used to store instructions for running one or more applications or modules on processor(s) 210. For example, memory 205 could be used in one or more embodiments to house all or some of the instructions needed to execute the functionality of communications module 215, GUI generation module 220, monitoring module 225, tracking module 230, aggregator 235, policy module 240, collection engine 245, compliance engine 250, report module 255, and spam module 260.

Communications module 215 can be used to translate messages and requests between the advertising compliance system and other systems (e.g., spam filters, billing systems, databases, ad servers, and others). Communications module 215 can translate messages or requests generated by one system into an appropriate message or request for another system. For example, communications module 215 may format a message from one language or protocol into the requirements, language, or protocols needed by another system.

GUI generation module 220 can generate one or more GUI screens that allow for interaction with a user of the advertising compliance system. In at least one embodiment, GUI generation module 220 generates a graphical user interface allowing submission of advertisements to be monitored, changing and/or reviewing advertisement policies, delivery of compliance indicators and/or reports, along with other functions. For example, in one embodiment, GUI generation module 220 may generate a dashboard detailing the level of compliance for multiple advertisements or advertising campaigns based on the results from the compliance engine. The dashboard can indicate which of the multiple advertisements are violating a set of compliance policies. The dashboard may also generate requests for remedying the compliance violations. In some cases, the dashboard may provide the user a vehicle for navigating compliance data (e.g., screen shots, reports, vendor costs, etc.) stored by advertising compliance system 110. For example, the dashboard may include links that when selected by the user retrieve additional data or details.

In accordance with various embodiments, monitoring module 225 may be configured to crawl or search the Internet to find placement of advertisements or to monitor known sites where advertisements should not be displayed. In some cases, monitoring module 225 may receive a list of websites to monitor along with a monitoring schedule indicating the frequency at which the websites should be monitored. In other cases, monitoring module 225 may receive one or more content categories from which the module can determine, find, and monitor appropriate websites satisfying the content identified by the content categories.

Tracking module 230 can be used by advertising compliance system 110 to track specific websites and domain names using monitoring module 225. These websites can be part of a track list of websites that are commonly requested by compliance engine 250. In some cases, tracking module 230 can use aggregator 235 to aggregate e-mail messages identified as spam from multiple sources and track phishing websites identified within the messages.

Policy module 240 can set and record the types of advertising compliance policies. Common examples include, but are not limited to, policies that have website exclusions based on content, a rate of appearance, target audience demographics, and number of inclusions on blacklisted websites. In some embodiments, compliance engine 250 may interact with policy module 240 in determining the compliance level of an advertisement or advertising campaign.

Collection engine 245 may take snapshots and collect other information about various websites at different periods of time. Collection engine 245 can then create entries within a database that can be used by compliance engine 250 to determine the compliance level of an advertisement or an advertising campaign. For example, compliance engine 250 may just search for specific web pages to determine that an advertisement appeared the desired number of times or at a desired frequency. In some embodiments, compliance engine 250 includes a comparator to compare the advertisement to portions of the indexed set of websites and generate a similarity score. The comparator can compare text and/or images from the advertisements to determine the similarity score. Compliance engine 250 can also determine (or score) the level of compliance with a set of advertising policies. The requirements set forth by the policies may be weighted evenly or unevenly depending on the scoring model. For example, an advertisement placed on a blacklisted website may be more heavily weighted than an advertisement placed on a specified website.

Report module 255 can receive the search and analysis results from compliance engine 250. Using this information, a compliance report may be generated. The compliance report may be transmitted to a requestor on a periodic, on pre-determined schedule, or upon detection of one or more events (e.g., outside of a compliance range). The report may be delivered through a graphical user interface generated by GUI generation module 220. In other cases, the report may be e-mailed, printed and mailed, faxed, or delivered through other methods.

Spam module 260, in accordance with various embodiments, can receive the e-mail messages from aggregator 235. The spam module can index content from messages identified as spam and by visiting each link within the e-mail messages. During the visit to each link, collection engine 245 can be used to record a snapshot (possibly several levels deep) of the website within the database. These snapshots can then be compared with other websites to determine a similarity score using text and/or image based comparisons.

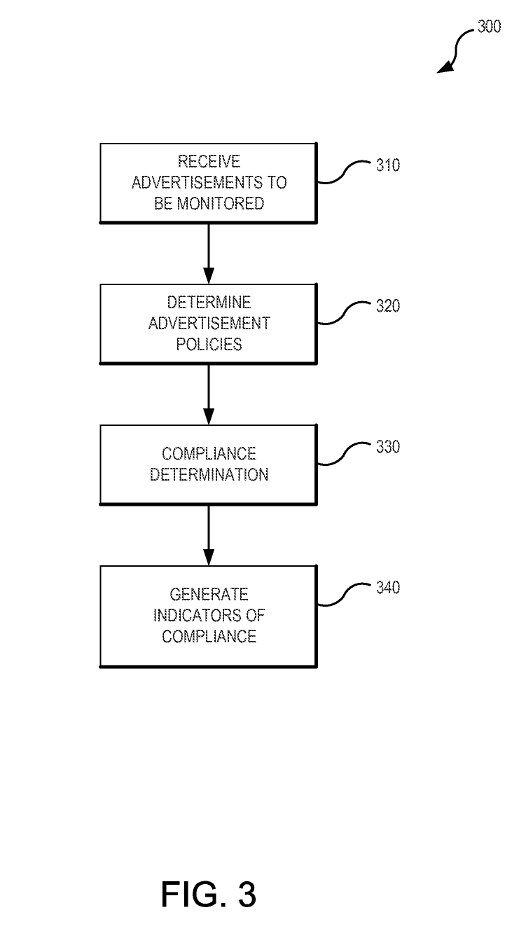

FIG. 3 is a flowchart illustrating exemplary operations 300 for determining an advertising compliance level in accordance with various embodiments of the present invention. The operations illustrated in FIG. 3 can be performed by various components of the advertising compliance system 110. In accordance with the embodiments illustrated in FIG. 3, receiving operation 310 receives a set of advertisements to be monitored. The advertisement (e.g., text advertisements or image advertisements) can be delivered through a graphical user interface or through a delivery portal. In some cases, the advertisements may have already been stored on an advertisement database and only an identification string is delivered.

Once the set of advertisements has been received, policy determination operation 320 determines the set of policies associated with each advertisement. In some embodiments, policy determination operation 320 may allow the user to review and/or update the policies. Compliance operation 330 then determines the level of compliance by the advertising service. In some embodiments, the system actively monitors websites and creates indexed entries of the websites within the database. In other embodiments, in order to conserve resources, the system may determine whether to create the indexed entry or not. For example, the system may only record or score positive compliance with the advertisement policies while creating indexed entries for advertisement placement that is in non-compliance.

The evaluation of compliance can occur over different periods of time to gauge trends in compliance. Generation operation 340 can generate one or more compliance indicators based on the level of compliance determined by compliance operation 330. The compliance indicators may provide a quick indication of high level of compliance or non-compliance, recommendations (e.g., for higher or lower levels of monitoring), granular indicators of compliance, etc.

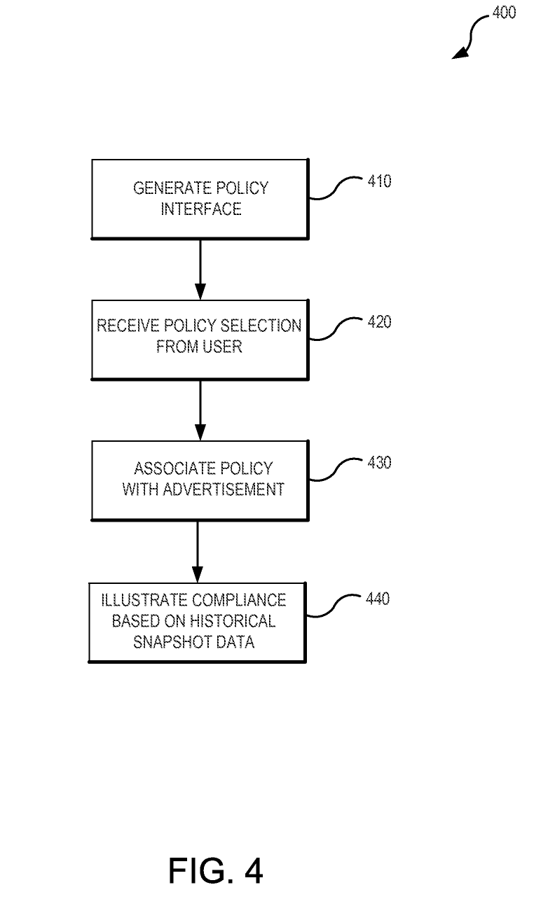

FIG. 4 is a flowchart illustrating exemplary operations 400 for setting advertising policies in accordance with some embodiments of the present invention. In accordance with various embodiments, one or more of these operations can be performed, at least in part, by a processor, communications module 215, a graphical user interface generated by GUI generation module 220, policy module 240, report module 255, and/or other components or modules. As illustrated in FIG. 4, interface generation operation 410 may generate a policy interface.

The policy interface, in some embodiments, can be a graphical user interface screen that allows the user to select one or more policies that can be associated with an advertisement, a group of advertisements, or advertising campaigns. For example, an automobile manufacture may not want advertisements for their latest car displayed on children's websites since children do no purchase such products. As such, the user can specifically identify websites not to advertise on or select a general category. Similarly, the user may decide that the advertisement should be placed on specific websites or websites with specific content. The user may also specify policies that indicate saturation or incidence rates on these websites.

Receiving operation 420 receives the policy selection from the user. Then, association operation 430 associates the policies with the specific advertisement or set of advertisements. In some cases, association operation 430 can perform a consistency review of contractual agreements and/or client objectives to ensure that the individual policies are consistent. If any discrepancies are identified these can be either flagged for review by the user or simply denied entry.

In some embodiments, historical compliance operation 440 can be used to illustrate how the policies received by the user have historically been performed and the impact the changes would have. For example, the desired policies for a long running advertising campaign may evolve over time and the advertiser may desire to refine the target audience (e.g., age demographic, etc). However, a review may indicate that several specific websites generate a large percentage of the traffic. Consequently, a historical analysis would highlight this and indicate the effect of the policy change.

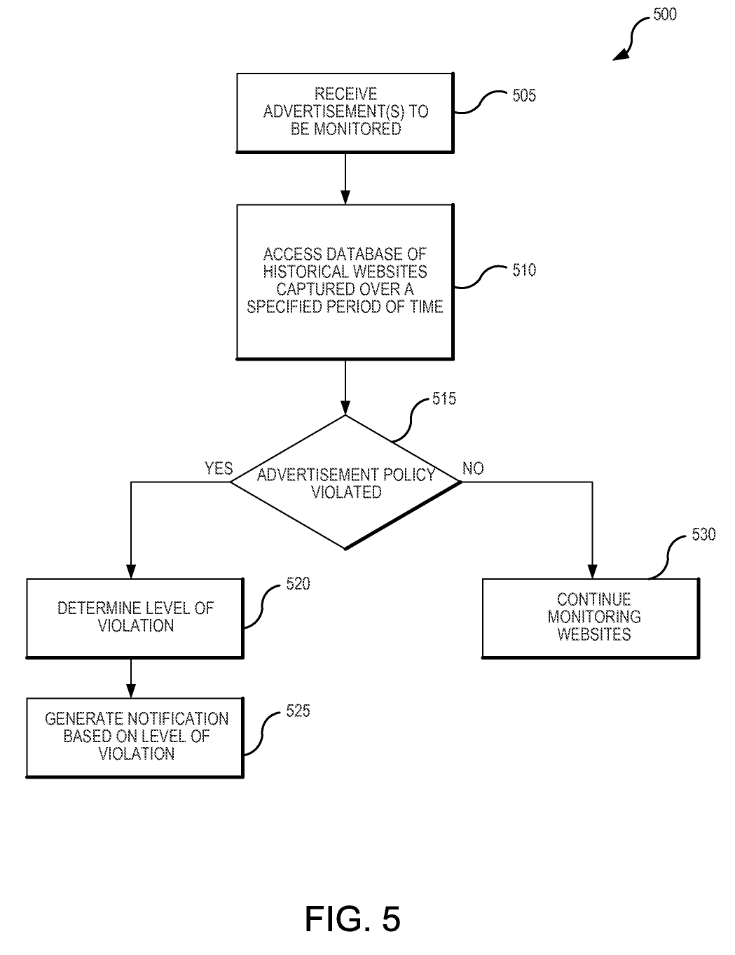

FIG. 5 is a flowchart illustrating exemplary operations 500 for monitoring and notification of advertising compliance in accordance with various embodiments of the present invention. One or more of the operations may be performed by processor(s) 210, policy module 240, compliance engine 250, and/or other system components. As illustrated in FIG. 5, receiving operation 505 receives one or more advertisements to be monitored for compliance. This can occur, for example, from the transfer of a data file and/or through a submission on a graphical user interface. In some cases, the graphical user interface may present a selection of advertisements that are available to be monitored or that have already been tracked and indexed within a historical database.

Once the advertisements have been selected or received, access operation 510 accesses one or more databases of historical websites or e-mails that have been captured over a period of time. In some cases, the database may be populated with entries captured by tracking module 230 or through data collected by a third party. Using the entries retrieved from the database, decision operation 515 determines whether an advertisement policy had been violated for each of the advertisements (or the set of advertisements collectively).

If decision operation 515 determines that the advertisement policy has been violated, then level determination operation 520 determines the level of violation. Using the level of violation determined by level determination operation 520, notification operation 525 can generate the appropriate notification (e.g., flag, e-mail, phone discussion request, etc.) based on the level of the violation. In some embodiments, notification operation 525 can include attaching documentation of the policy violations. For example, images of the website with the advertisement can be collected possibly along with other information such as time stamps, copies or links to advertisement policy, previous notifications of noncompliance, and/or other information which can be useful in building a case of noncompliance.

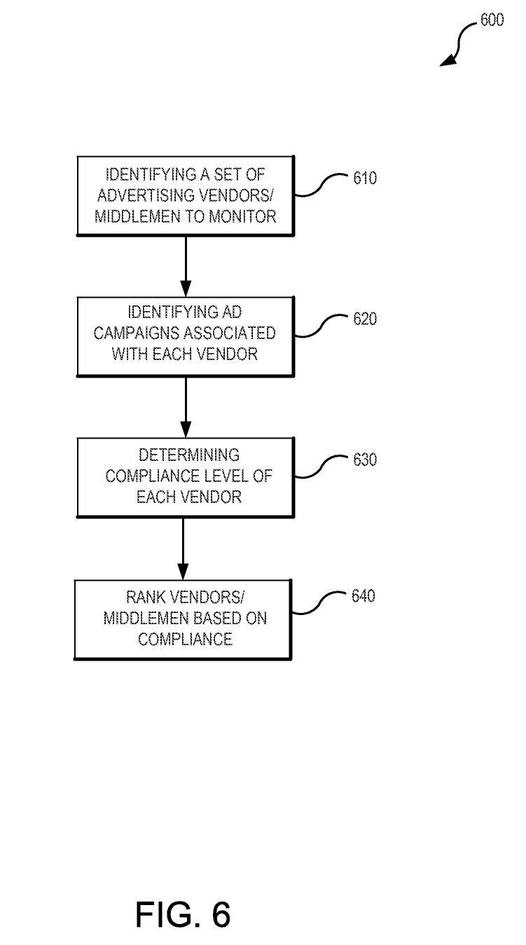

FIG. 6 is a flowchart illustrating exemplary operations 600 for ranking advertising vendors in accordance with various embodiments of the present invention. One or more of the operations may be performed by processor(s) 210, monitoring module 225, compliance engine 250, and/or other system components. As illustrated in FIG. 6, vendor identification operation 610 identifies a set of advertising vendors to monitor. These vendors can be randomly selected, selected by a user of advertising compliance system 110 (e.g., through a graphical user interface screen), and/or automatically selected. For example, the vendors can be automatically selected based on a periodic audit schedule, upon detection of an event such as noncompliance, upon completion of a campaign, etc. In addition, the level of review associated with each vendor can be selected. For example, a full review, an intermediate review, or a categorical review (e.g., a review of banner advertisements). In accordance with various embodiments, each vendor can be identified with a unique vendor identifier that allows the compliance system to pull data associated with the vendor.

Advertisement identification operation 620 identifies campaigns associated with each vendor and the associated campaign policies for the distribution of the advertisements associated with the campaigns. Determination operation 630 can determine a compliance level for each vendor. The compliance level can include a general compliance level and/or categorical compliance levels. For example, categorical compliance levels can include advertisement categories (e.g., interstitial advertisements, banner advertisements, etc.), policy categories, target audience categories, geographical categories, or other categories. Using the compliance levels, ranking operation 640 can rank the vendors based on compliance. If a significant noncompliance is determined, this information can be used to terminate the contract, ask for a refund, or modify future business with the vendor. In some cases, these rankings may identify that some vendors are better at ensuring compliance within certain categories. As a result, these rankings can be used in selecting vendors for particular types of campaigns. This information may be used within a feedback loop within the system for adjusting payment and/or selecting vendors.

### Exemplary Computer System Overview

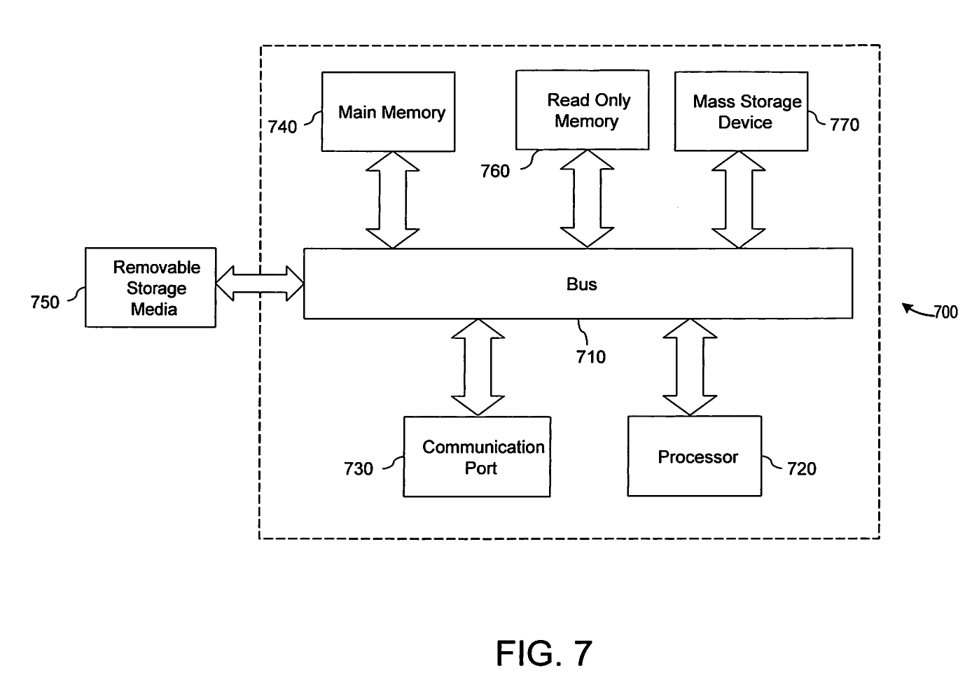

Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 7 is an example of a computer system 700 with which embodiments of the present invention may be utilized. According to the present example, the computer system includes a bus 710, at least one processor 720, at least one communication port 730, a main memory 740, a removable storage media 750, a read only memory 760, and a mass storage 770.

Processor(s) 720 can be any known processor, such as, but not limited to, an Intel® Itanium® or Itanium 2® processor(s), or AMD® Opteron® or Athlon MP® processor(s), or Motorola® lines of processors. Communication port(s) 730 can be any of an RS-232 port for use with a modem based dialup connection, a 10/100 Ethernet port, or a Gigabit port using copper or fiber. Communication port(s) 730 may be chosen depending on a network such a Local Area Network (LAN), Wide Area Network (WAN), or any network to which the computer system 700 connects.

Main memory 740 can be Random Access Memory (RAM), or any other dynamic storage device(s) commonly known in the art. Read only memory 760 can be any static storage device(s) such as Programmable Read Only Memory (PROM) chips for storing static information such as instructions for processor 720.

Mass storage 770 can be used to store information and instructions. For example, hard disks such as the Adaptec® family of SCSI drives, an optical disc, an array of disks such as RAID, such as the Adaptec family of RAID drives, or any other mass storage devices may be used.

Bus 710 communicatively couples processor(s) 720 with the other memory, storage and communication blocks. Bus 710 can be a PCI/PCI-X or SCSI based system bus depending on the storage devices used.

Removable storage media 750 can be any kind of external hard-drives, floppy drives, IOMEGA® Zip Drives, Compact Disc—Read Only Memory (CD-ROM), Compact Disc—Re-Writable (CD-RW), or Digital Video Disk—Read Only Memory (DVD-ROM).

The components described above are meant to exemplify some types of possibilities. In no way should the aforementioned examples limit the scope of the invention, as they are only exemplary embodiments.

In conclusion, the present invention provides novel systems, methods and arrangements for determining advertising compliance and relevance. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the appended claims.

What is claimed is:

1. A method for monitoring advertising compliance, the method comprising:
receiving a set of advertisements to be monitored as the set of advertisements are published across one or more computer network based delivery mechanisms, wherein each advertisement identified in the set of advertisements is associated with an advertisement policy;
submitting, via a network, the set of advertisements to a compliance engine, wherein the compliance engine determines compliance with the advertisement policy associated with each advertisement;
receiving, from the compliance engine, a compliance status for the set of advertisements.

2. The method of claim 1, wherein the set of advertisements are part of an advertising campaign.

3. The method of claim 1, wherein the set of advertisements includes text advertisements and image advertisements.

4. The method of claim 1, wherein the set of advertisements includes contextual advertisements placed on search engine results pages, banner advertisements, social network advertisements, hyperstitial advertisements, interstitial advertisements, online classified advertisements, dynamic banner advertisements, cross-platform advertisements, or e-mail marketing advertisements.

5. The method of claim 1, wherein the set of advertisements includes an identification number to identify a specific advertisement stored within a database.

6. The method of claim 5, wherein submitting the set of advertisements to the compliance engine includes transferring the identification number.

7. The method of claim 1, wherein the set of advertisements includes text associated with a text advertising campaign.

8. The method of claim 7, wherein the set of advertisements includes a subject matter exclusion list identifying types of websites within which the set of advertisements should not be displayed.

9. The method of claim 8, wherein the subject matter exclusion list includes media piracy, criminal behavior, gambling, drugs, alcohol, emergency, profanity, sexual content, and error pages.

10. An advertisement compliance system comprising:
a processor;
a database having stored thereon an indexed set of websites;
a monitoring module configured to crawl the Internet and create entries within the database;
a compliance engine to receive an advertisement and search the indexed set of websites within the database for the advertisement; and
a report module to receive search results from the compliance engine and to use the processor to generate a compliance report.

11. The system of claim 10, wherein the advertisement is a text advertisement or an image advertisement.

12. The system of claim 10, wherein the compliance engine includes a comparator to compare the advertisement to portions of the indexed set of websites and generate a similarity score.

13. The system of claim 10, further comprising:
an aggregator to aggregate messages identified as spam from multiple sources; and
a spam module to receive the messages from the aggregator, wherein the spam module is configured to index content from messages identified by visiting each link within the messages and storing a snapshot within the database.

14. The system of claim 10, wherein the compliance report is transmitted to a requestor on a periodic or pre-determined schedule.

15. The system of claim 10, wherein the compliance engine generates a compliance score for each advertisement and the system further comprises a graphical user interface module to generate a dashboard for multiple advertisements compliance based on the compliance score generated by the compliance engine.

16. The system of claim 15, wherein the dashboard indicates which of the multiple advertisements are violating a set of compliance policies.

17. The system of claim 16, further wherein the set of compliance policies include website exclusions based on content, rate of appearance, and number of inclusions on blacklisted websites.

18. The system of claim 10, wherein the compliance engine generates a campaign compliance score, a categorical compliance score, or a vendor compliance score.

19. A computer-implemented method comprising:
generating, using a processor, a submission interface to receive advertising entries from a user;
submitting the entries to a compliance engine to determine compliance with a set of advertising policies;
receiving a compliance report from the compliance engine; and
displaying a dashboard on a terminal device, wherein the dashboard includes a summary for each advertising entry based on the compliance report.

20. The computer-implemented method of claim 19, further comprising, upon selection of one of the advertising entries displayed on the dashboard, displaying an advertisement detail interface that includes details from the compliance report.

21. The computer-implemented method of claim 19, wherein the advertisement detail interface allows the user to request future advertisement to not be displayed on a specific webpage.

22. The computer-implemented method of claim 19, wherein the advertisement detail interface includes content categories identifying content type found on a webpage displaying each advertising entry.

23. The computer-implemented method of claim 22, wherein the content categories include media piracy, crime, gambling, drugs, alcohol, profanity, sexuality, or error pages.

24. The computer-implemented method of claim 22, wherein the advertisement detail interface retrieves an image snapshot of the webpage upon detecting a cursor is within proximity of one of the advertising entries.

25. A computer-readable storage medium containing a set of instructions capable of causing one or more processors to:
receive a text advertisement to be monitored, wherein the text advertisement is associated with an advertisement policy;
determine if the text advertisement is in compliance with the advertisement policy; and
generate one or more indicators of compliance with the advertisement policy.

26. The computer-readable storage medium of claim 25, wherein the advertisement policy includes a target appearance rate, a blacklist of websites, a mandatory appearance website list, or an unacceptable content list.

27. The computer-readable storage medium of claim 25, wherein the set of instructions further cause the one or more processors to scan the content of specified websites.

28. The computer-readable storage medium of claim 25, wherein the set of instructions further cause the one or more processors to collect messages identified as spam.

29. The computer-readable storage medium of claim 28, wherein the set of instructions further cause the one or more processors to index content from the messages and record snapshots of websites identified within the messages.

30. The computer-readable storage medium of claim 29, wherein the set of instruction further cause the one or more processors to generate a similarity score by comparing a set of images from target domains with the snapshots recorded from the websites identified within the messages.

31. A computer-implemented method for evaluating advertising compliance, the computer-implemented method comprising:
identifying a set of advertisements that will be published in accordance with one or more advertising campaigns assigned to a vendor, wherein each advertisement identified in the set of advertisements is associated with a campaign advertisement policy;
submitting, via a network, the set of advertisements to a compliance engine, wherein the compliance engine determines compliance with the campaign advertisement policy associated with the one or more advertising campaigns;
receiving, from the compliance engine, a vendor rating for the vendor servicing the one or more advertising campaigns.

32. The computer-implemented method of claim 31, wherein the campaign advertising policy includes a blacklist of websites where the set of advertisements should not be displayed.

33. The computer-implemented method of claim 32, further comprising crawling websites identified on the blacklist of websites and recording images of the websites when an advertisement from the set of advertisements appears.

34. The computer-implemented method of claim 33, further comprising generating a vendor report having compliance information and the images of the websites where the advertisement should not have been displayed.

35. The computer-implemented method of claim 31, wherein the campaign advertising policy includes a subject matter exclusion list identifying subject matter of webpages where the set of advertisements should not be displayed.

36. A system for evaluating advertising compliance, the system comprising:
a means for identifying a set of advertisements that will be published in accordance with one or more advertising campaigns assigned to a vendor, wherein each advertisement identified in the set of advertisements is associated with a campaign advertisement policy;
a means for submitting the set of advertisements to a compliance engine, wherein the compliance engine determines compliance with the campaign advertisement policy associated with the one or more advertising campaigns;
a means for generating a vendor rating for the vendor servicing the one or more advertising campaigns.

37. The system of claim 36, wherein the campaign advertising policy includes a blacklist of websites where the set of advertisements should not be displayed and the system further includes a means for crawling websites identified on the blacklist of websites.

38. The system of claim 37, further comprising a means for recording images of the websites when an advertisement from the set of advertisements appears.

39. The system of claim 36, further comprising a means for adjusting billings to the vendor based on noncompliance with the campaign advertisement policy.

40. The system of claim 36, wherein the set of advertisements includes contextual advertisements placed on search engine results pages, banner advertisements, social network advertisements, hyperstitial advertisements, interstitial advertisements, online classified advertisements, dynamic banner advertisements, cross-platform advertisements, or e-mail marketing advertisements.
